(19) United States
(12) Patent Application Publication
(10) Pub. No.: US 2015/0135491 A1
(43) Pub. Date: May 21, 2015

(54) INTERCHANGEABLE AND DETACHABLE FLANGE FOR CONNECTOR

(71) Applicant: VOLEX PLC, London (GB)

(72) Inventors: Lim Boon Leng, Singapore (SG); Mui Lian Jessica Toh, Singapore (SG)

(21) Appl. No.: 14/542,506

(22) Filed: Nov. 14, 2014

Related U.S. Application Data
(60) Provisional application No. 61/904,862, filed on Nov. 15, 2013.

(51) Int. Cl. H01R 13/62; H01R 13/64

(52) U.S. Cl. CPC H01R 13/62; H01R 13/64
USPC 24/596.1

(57) ABSTRACT

An interchangeable and detachable flange for a connector is described. A flange with a circular opening can be secured to an electrical or other type of connector by a locking mechanism. The locking mechanism is engaged and disengaged by twisting the flange around the connector. The locking mechanism may consist of a tongue that slides into a slot when the flange is twisted around the connector, and may further consist of a raised knob that fits into a recess for the raised knob.

### CROSS REFERENCE TO RELATED APPLICATIONS

This application claims benefit under 35 U.S.C. § 119(e) of Provisional U.S. Patent Application No. 61/904,862, filed Nov. 15, 2013, the contents of which is incorporated herein by reference in its entirety.

### TECHNICAL FIELD

The present disclosure relates to connectors for providing an electrical power connection or electrical or optical signal connections. In particular, it relates to an interchangeable and detachable flange of a connector.

### BACKGROUND

Electrical power and optical signal cables may have plugs or connectors at an end of a cable fitted with a flange that surrounds the connector or cable. Such a flange has several possible uses, including physically strengthening a connector attachment to an inlet, improving the visual appearance of a connection, guiding a connector correctly into an inlet, indicating a full engagement between the connector and the inlet by virtue of the flange resting flush with the panel opening, or providing extra protection for the inlet once plugged in. Example connectors include the electrical power connectors in the International Electrotechnical Commission (IEC) 60320 standard.

### SUMMARY

An interchangeable and detachable flange for a connector housing is disclosed, comprising an interior wall forming a circular opening within the interchangeable and detachable flange, and a first part of an at least one locking mechanism formed on the interior wall for engaging a second part of the at least one locking mechanism attached to a surface of the connector, wherein: the first part is configured to engage with the second part when the first part is aligned with second part and the first part is rotated relative to the second part until the first part is locked with the second part; and the first part is configured to disengage with the second part when the first part is rotated relative to the second part until the first part is unlocked from the second part.

A connector is also disclosed, comprising: one or more curved outer edges along a length of the connector; and one or more first sides of a locking mechanism appended to the curved outer edges, the one or more first sides configured to attach an interchangeable and detachable flange to the connector, the interchangeable and detachable flange including one or more second sides of the locking mechanism, wherein the one or more first sides are configured to engage and disengage with the one or more second sides when the one or more first sides are aligned with the one or more second sides and the interchangeable and detachable flange is rotated relative to the connector.

### BRIEF DESCRIPTION OF THE DRAWINGS

FIG. 1A is a perspective view of a flange in accordance with an embodiment detached from a C7 connector.

FIG. 1B is a perspective view of a detachable flange in accordance with an embodiment locked into place on a C7 connector.

FIG. 2 is a perspective view illustrating details of an embodiment of a connector housing and a flange forming a locking mechanism.

FIG. 3A is a cross-sectional view of an embodiment of a flange in an unlocked position.

FIG. 3B is a cross-sectional view of an embodiment of a flange in a locked position.

FIG. 4A is a perspective view illustrating an embodiment of a round flange.

FIG. 4B is a perspective view illustrating an embodiment of a square flange.

### DETAILED DESCRIPTION OF ILLUSTRATIVE EMBODIMENTS

This disclosure provides details of an interchangeable and detachable flange. In some embodiments, such a flange can have a circular opening and a locking mechanism for securely attaching the flange to an object, such as connector housing, inserted into the circular opening. The ability to change the flange attached to a connector can be useful in many scenarios. A primary purpose of standards such as IEC 60320 is to promote interchangeability, as such it allows connectors from one manufacturer to work with inlets from another manufacturer, when both of the connectors and inlets meet the standard. When a flange is desired, an interchangeable and detachable flange allows a single connector to be used with multiple manufacturers' inlets. In one scenario, the flange specifications, such as shape, color, or material, may be chosen to match the inlet panel hole from one manufacturer, but the flange must also attach to the connector from another manufacturer. An interchangeable and detachable flange allows the interoperability of the connectors and inlets to be retained where a flange is necessary or desired. Another scenario where an interchangeable and detachable flange is useful is a single manufacturer's connector and inlet, but different customer use environments that require different flanges or no flange at all.

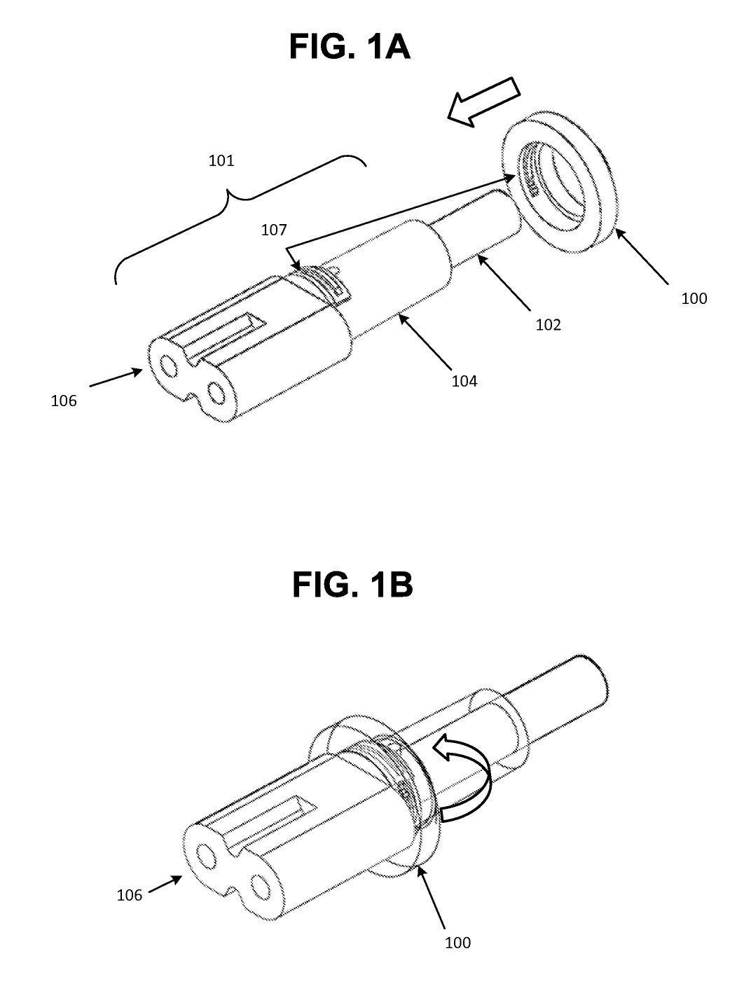

FIG. 1A depicts a detached flange 100 and a typical type of electrical power connector 101 around which the flange 100 may be attached. In this embodiment, an unlocked flange 100 can slide over a cable 102 and an overmold 104 toward a connector housing 106 having one half, side, or part, of a locking mechanism 107, the other half, side, or part, of which may be formed within the flange 100. The connector housing 106 in this example is in the shape of an IEC 60320 standard C7 electrical power plug or connector, but the present disclosure can also be applied, without limitation, to a variety of other connector types, including IEC 60320 C1, C5, C13, C15, C17, and C19 standard connectors. Flange 100, overmold 104 and connector housing 106 may be formed within injection molds of a thermoplastic material or in other manners using other materials suitable for the manufacture of connectors. FIG. 1B shows the flange 100 attached and rotated relative to the connector housing 106 to engage the first part of the locking mechanism 107 in the connector housing 106 with the second part of the locking mechanism 108 in the flange 100.

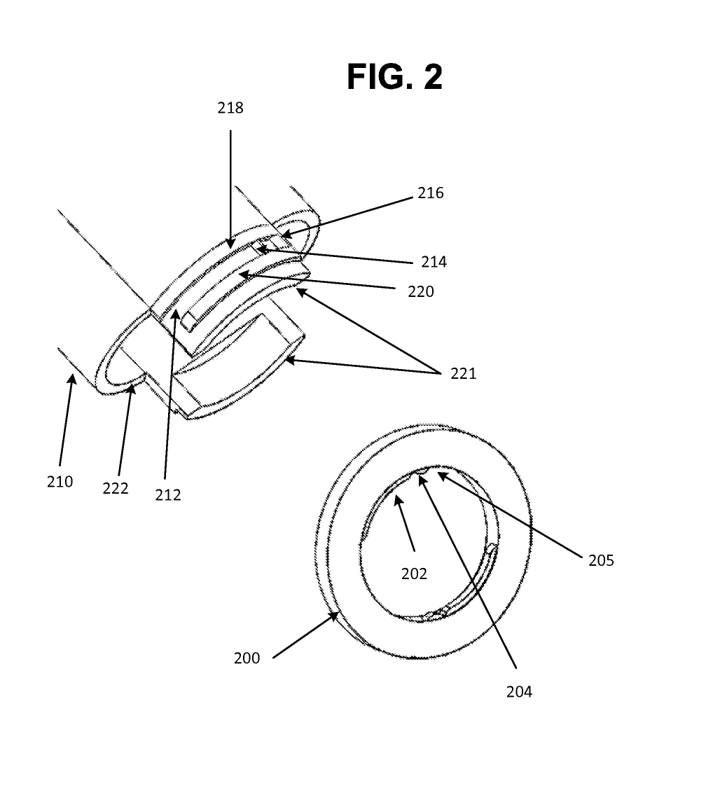

FIG. 2 highlights details of one embodiment of a locking mechanism 107 of FIG. 1A. As noted, one half of the locking mechanism 107 may be formed in the flange 200 as a tongue 202 and a divot 204 formed within the tongue 202 between a bump 205 at one end of the tongue 202 and the remainder of the tongue 202. The other half of the locking mechanism 107 may be formed in the connector housing 210 as a slot 212, with a raised knob 214 somewhere along the length of the slot 212, and with a rotational stopper 216 formed at one end of the slot 212. A space may be formed within the slot 212 between the raised knob 214 and the rotational stopper 216. The slot 212 may be formed between a raised edge 218 of the housing 210 and a raised bar 220 that runs parallel to the raised edge 218, although the bar 220 is optional. For example, rather than forming the slot 212 between the raised bar 220 and the raised edge 218, the slot 212 may be a groove formed within the surface of a tab 221 of the connector housing 210 (tab 221 is illustrated as a curved outer edge of the connector housing) extending from the raised edge 218 such that the raised bar 220 is just part of the surface of tab 221 that extends from the remainder of the connector housing 210 rather than a separate raised bar 220. The two halves of the locking mechanism 107 may be brought together so as to lock flange 200 onto connector housing 210 by first aligning the tongue 202 with the slot 212 along a circular band having an origin or center on the axis of the cable 102. The alignment between the tongue 202 and the slot 212 can be facilitated by the optional linear stopper 222 that stops the flange 200 from sliding further down the connector housing 210 at exactly the point where the tongue 202 and the slot 212 are to be aligned. Alternatively, or in addition, the flange 200 can be stopped from sliding where the tongue 202 and the slot 212 are to be aligned by the portion of the raised edge 218 that extends beyond the end of the bar 220. After slot 212 and tongue 202 are aligned, the flange 200 may be twisted rotationally around the axis of the cable 102, i.e., relative to the connector housing 210, causing the tongue 202 to slide into the slot 212 until the end of the tongue 202 by the divot 204 moves over the raised knob 214 and hits the rotational stopper 216. The rotational stopper 216 may be formed and positioned such that the raised knob 214 will fit snugly within the divot 204 when the end of the tongue 202 hits the rotational stopper 216.

The movement of the raised knob 214 over the end of the tongue 202 may generate some level of resistance and require the flange 200 to be twisted a little harder to overcome that resistance so that the raised knob 214 may move over the end of the tongue 202 and settle in the divot 204. This interaction may be facilitated in a number of ways. For example, the material of the flange may be designed to yield and flex to enable the raised knob to move over the tongue. Alternatively, the tab 221 may flex downward slightly to accommodate the pressure exerted by the flange 200 against the tab 221 when so twisted. A similar amount of force or pressure may likewise need to be exerted to overcome the resistance created by the raised knob 214 sitting within the divot 204 if and when the flange 200 is turned the opposite direction to remove the flange 200 from the connector housing 210.

In an embodiment not depicted in FIG. 2, but sufficiently clear from the elements depicted in FIG. 2, the first lock part and second lock part may be swapped, such that the tongue 202 and divot 204 may be formed in the connector housing 210 instead of the flange 200 and the slot 212, raised knob 214 and rotational stopper 216 may be formed within the flange 200 instead of the connector housing 210. In another embodiment not depicted in FIG. 2, but sufficiently clear from the elements depicted in FIG. 2, a flange forming a first lock part may be matched to a separate second lock element formed on a ring that may be independent of any connector or cable but may be attached to a connector or cable via adhesive or other such means.

Other embodiments include swapping the raised knob 214 and divot 204, such that the raised knob 214 may be formed on the tongue 202 when the divot 204 is formed in the slot 212. In addition, while FIGS. 1A and 2, in particular, illustrate the overmold 104 fitting between the two tabs 221 of the connector housing 106/210, instead of having the two tabs 221, the connector housing 106/210 may form a solid ring at its end so that connector housing 106/210 fits fully over the overmold 104 where the two pieces meet. Further, while the figures herein illustrate a locking mechanism 107 of approximately the same size formed on opposing sides of the connector housing and flange, each of the locking mechanism could be of a different size, or only a single locking mechanism 107 may be utilized, or more than two locking mechanisms 107 may also be utilized. Many other variations could likewise be imagined by a person of ordinary skill in the art after reading the present disclosure.

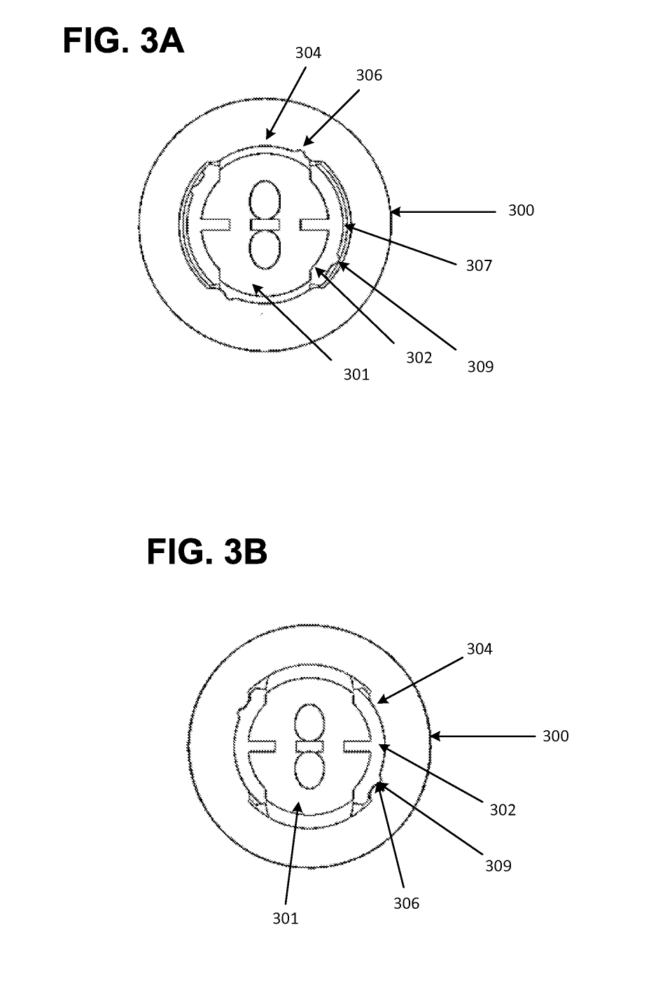

FIG. 3A shows a cross-sectional view of flange 300, overmold 301, and the tab 302 of the connector housing prior to the flange 300 being rotated to lock the flange 300 onto the connector housing 302, while FIG. 3B shows the flange 300 in the locked position. In the example embodiment of FIG. 3A, flange 300 has two tongues 304 and divots 306 on opposite sides of the flange 300, and the connector housing 302 has two slots 307 and raised knobs 309 on opposite sides of the connector housing 302. As shown in both FIGS. 3A and 3B, the tongues 304 are already aligned with the slots 307. In FIG. 3B, the flange 300 has been twisted relative to the connector housing 302, sliding the tongue 304 into, and all the way to the end of, the slot 307, such that slot 307 is filled with the tongue 304, and the raised knob 309 is now snugly seated in the divot 306, effectively locking the flange 300 in place onto the connector housing 302. Note that the divots 306 and raised knobs 309 of both locking mechanisms on opposite sides of the flange 300 and connector housing 302 are simultaneously seated in place.

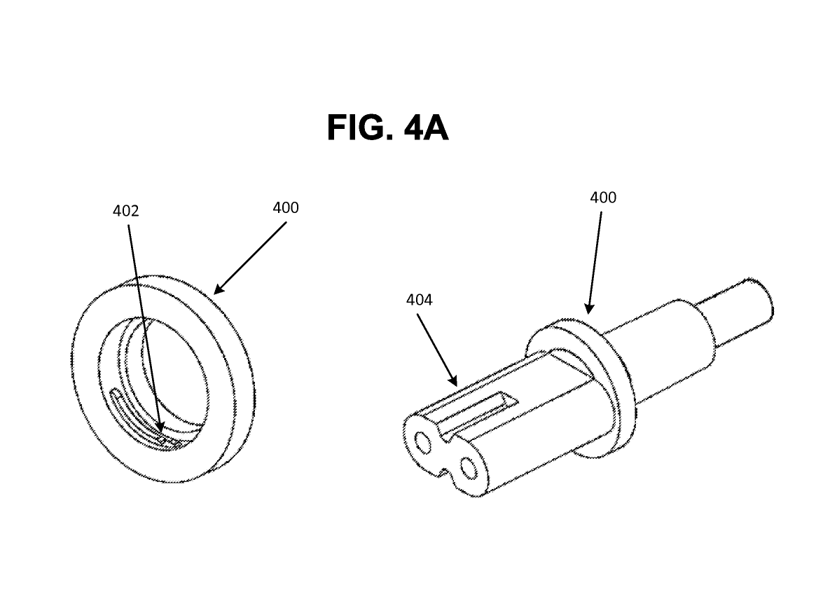

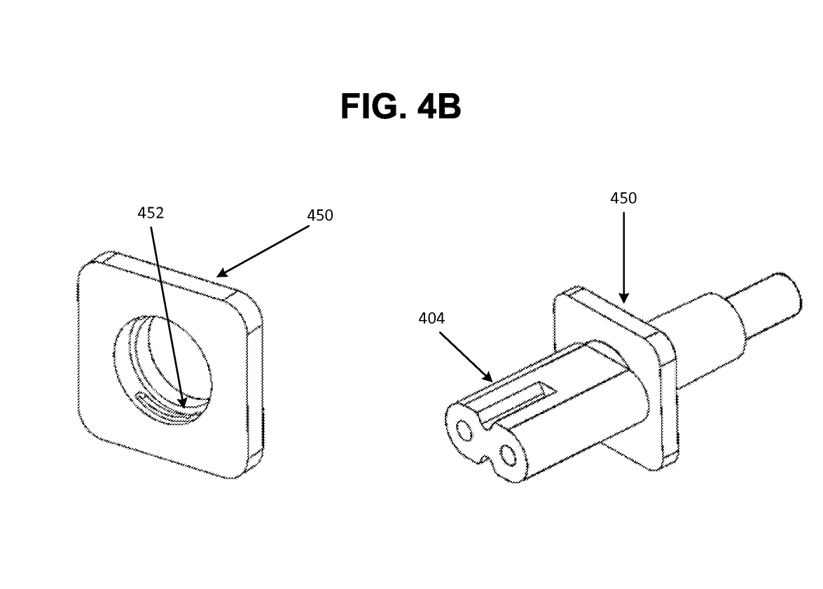

FIG. 4A and FIG. 4B show that flanges of different exterior geometry or dimensions can be interchanged on the same connector by having the same type of circular opening and locking mechanisms. In the embodiment of FIG. 4A, a round flange 400, with one half of a locking mechanism 402 inside a circular opening formed by the circular interior walls of the round flange 400, can be attached to connector 404 as shown. In FIG. 4B, a rectangular flange 450, with a substantially identical locking mechanism 452 and circular opening formed by its circular interior walls, can likewise be attached to connector 404. The round or rectangular exterior of the flange would be formed in the exterior wall of the flanges 400 or 450. The outer wall of the flange may also have any one of a plurality of different shapes other than round or rectangular.

Although embodiments of the present disclosure have been illustrated in conjunction with the accompanying drawings and described in the foregoing detailed description, it should be appreciated that the invention is not limited to the embodiments disclosed and is capable of numerous rearrangements, modifications, alternatives, and substitutions without departing from the spirit of the disclosure as set forth and recited by the following claims.

What is claimed:

1. An interchangeable and detachable flange for a connector housing, comprising:
an interior wall forming a circular opening within the interchangeable and detachable flange; and
a first part of an at least one locking mechanism formed on the interior wall for engaging a second part of the at least one locking mechanism attached to a surface of the connector, wherein:
the first part is configured to engage with the second part when the first part is aligned with second part and the first part is rotated relative to the second part until the first part is locked with the second part; and
the first part is configured to disengage with the second part when the first part is rotated relative to the second part until the first part is unlocked from the second part.

2. The interchangeable and detachable flange as recited in claim 1, wherein:
the first part includes a tongue raised from the interior wall, the tongue having a first end and a second end and forming a divot near the first end;
the second part includes a slot formed within the surface of the connector housing and a raised knob within the slot; and
the tongue and slot are configured such that when the tongue and slot are aligned and the tongue is rotated within the slot until the first end moves over the raised knob and the raised knob settles within the divot the first part is locked with the second part.

3. The interchangeable and detachable flange as recited in claim 2, wherein:
the second part further includes a rotational stopper formed at the end of the slot for stopping rotation of the first part relative to the second part and forming a space between the raised knob and the rotational stopper;
and wherein the first part further includes a bump formed near the first end of the tongue so as to form the divot between the bump and a remainder of the tongue; and
wherein the lock is secured when the bump on the tongue fits securely in the space on the slot.

4. The interchangeable and detachable flange as recited in claim 1, wherein:
the first part includes a slot formed within the interior wall and a raised knob within the slot;
the second part includes a tongue attached to the surface of the connector housing, the tongue having a first end and a second end and forming a divot near the first end; and
the tongue and the slot are configured such that when the tongue and slot are aligned and the tongue is rotated within the slot until the first end moves over the raised knob and the raised knob settles within the divot the first part is locked with the second part.

5. The interchangeable and detachable flange as recited in claim 4, wherein:
the first part further includes a rotational stopper formed at the end of the slot for stopping rotation of the first part relative to the second part;
a space formed in the slot between the raised knob and a stopper at the end of the slot;
a bump is formed on the tongue between the divot and the first end of the tongue; and
the lock is secured when the bump on the tongue fits securely in the space on the slot.

6. The interchangeable and detachable flange as recited in claim 1, wherein the connector includes an overmold and the surface of the connector is a surface of the overmold.

7. The interchangeable and detachable flange as recited in claim 1, wherein:
the second part of the at least one locking mechanism is formed on a second ring configured to fit inside the circular opening of the interchangeable and detachable flange; and
the second ring being configured to fit around an outside of the connector housing and be attached to the outside of the connector housing by an adhesive.

8. The interchangeable and detachable flange as recited in claim 1, wherein the interchangeable and detachable flange includes an exterior wall, the exterior wall being circular.

9. The interchangeable and detachable flange as recited in claim 1, wherein the interchangeable and detachable flange includes an exterior wall, the exterior wall being rectangular.

10. The interchangeable and detachable flange as recited in claim 1, wherein the interchangeable and detachable flange includes an exterior wall, the exterior wall being any one of a plurality of shapes other than round or rectangular.

11. A connector, comprising:
one or more curved outer edges along a length of the connector; and
one or more first sides of a locking mechanism appended to the curved outer edges, the one or more first sides configured to attach an interchangeable and detachable flange to the connector, the interchangeable and detachable flange including one or more second sides of the locking mechanism, wherein the one or more first sides are configured to engage and disengage with the one or more second sides when the one or more first sides are aligned with the one or more second sides and the interchangeable and detachable flange is rotated relative to the connector.

12. The connector as recited in claim 11, wherein:
the one or more first sides include one or more tongues raised from the one or more curved outer edges, the one or more tongues each having a first end and a second end and forming a divot near the first end;
the one or more second sides include one or more slots formed within an interior wall forming a circular opening of the interchangeable and detachable flange and a raised knob within each slot; and
the one or more tongues and the one or more slots are configured such that when each tongue and each slot are aligned and the tongue is rotated relative to the slot, the first end of the tongue is configured to move over the raised knob of each slot and settle within the divot of each tongue.

13. The connector as recited in claim 12, wherein:
each slot includes a rotational stopper formed at the end of each slot for stopping rotation of the first side relative to the second side and forming a space between the raised knob and the rotational stopper;
and wherein the first side further includes a bump formed near the first end of each tongue so as to form the divot between the bump and a remainder of each tongue; and
wherein the locking mechanism is secured when the bump on each tongue fits securely in the space on each slot.

14. The connector as recited in claim 11, wherein:
the one or more first sides include one or more slots formed within the one or more curved outer edges and a raised knob within each slot;
the one or more second sides include one or more tongues appended to an interior wall forming a circular opening of the interchangeable and detachable flange, each tongue having a first end and a second end and forming a divot near the first end; and
each tongue and each slot are configured such that when each tongue and each slot are aligned and each tongue is rotated within each slot until the first end moves over the raised knob and the raised knob settles within the divot the first side is locked with the second side.

15. The connector as recited in claim 14, wherein:
the one or more first sides further include a rotational stopper formed at the end of each slot for stopping rotation of the first side relative to the second side;
a space formed in each slot between the raised knob and a stopper at the end of each slot;
a bump is formed on each tongue between the divot and the first end of each tongue; and
the locking mechanism is secured when the bump on the tongue fits securely in the space on the slot.

16. The connector as recited in claim 11, wherein the connector includes an overmold that fits between the one or more curved outer edges.

17. The connector as recited in claim 11, wherein:
the one or more second sides of the locking mechanism are formed on a second ring configured to fit inside a circular opening of the interchangeable and detachable flange; and
the second ring being configured to fit around the one or more curved outer edges and be attached to the one or more curved outer edges by an adhesive.

18. The connector as recited in claim 11, wherein the interchangeable and detachable flange includes an exterior wall, the exterior wall being circular.

19. The connector as recited in claim 11, wherein the interchangeable and detachable flange includes an exterior wall, the exterior wall being rectangular.

20. The connector as recited in claim 11, wherein the interchangeable and detachable flange includes an exterior wall, the exterior wall being any one of a plurality of shapes other than round or rectangular.
